(19) United States
(12) Patent Application Publication
(10) Pub. No.: US 2015/0138112 A1
(43) Pub. Date: May 21, 2015

(54) FORCE SENSOR MODULE FOR APPLYING A PRELOAD FORCE TO A FORCE SENSOR

(71) Applicant: NextInput, Inc., Atlanta, GA (US)

(72) Inventors: Ian Campbell, Smyrna, GA (US); Ryan Diestelhorst, Atlanta, GA (US)

(21) Appl. No.: 14/536,734

(22) Filed: Nov. 10, 2014

Related U.S. Application Data
(60) Provisional application No. 61/906,557, filed on Nov. 20, 2013.

(51) Int. Cl. G06F 3/041; G01L 1/14

(52) U.S. Cl. CPC G06F 3/0414; G01L 1/142
USPC 345/173; 73/862.626; 29/832

(57) ABSTRACT

An example force sensor module for a touch-sensitive electronic device can include a force sensor, a bias assembly and an opposing bias assembly that is coupled to the bias assembly. The bias assembly can have a top wall and a plurality of side walls extending from the top wall. The top and side walls can define a chamber. The force sensor can be arranged between the bias assembly and the opposing bias assembly within the chamber. Additionally, the bias and opposing bias assemblies can be configured to apply a preload force to the force sensor, which is approximately equal to a spring force exerted between the bias and opposing bias assemblies.

This application claims the benefit of U.S. Application No. 61/906,557, filed on Nov. 20, 2013.

### BACKGROUND

Touch screens have been widely employed in electronic devices, particularly in consumer electronic devices. For example, touch screens have replaced traditional input devices (e.g., buttons, keys, knobs, scrolls, etc.) on the consumer electronic devices. A variety of touch screen technologies, including resistive, capacitive, surface acoustic wave, optical, etc., are known in the art. These touch screen technologies can be used to sense when and where an operator makes contact with the touch screen. This information can be used to control operations of the consumer electronic devices.

### SUMMARY

An example force sensor module for a touch-sensitive electronic device can include a force sensor, a bias assembly and an opposing bias assembly that is coupled to the bias assembly. The bias assembly can have a top wall and a plurality of side walls extending from the top wall. The top and side walls can define a chamber. The force sensor can be arranged between the bias assembly and the opposing bias assembly within the chamber. Additionally, the bias and opposing bias assemblies can be configured to apply a preload force to the force sensor, which is approximately equal to a spring force exerted between the bias and opposing bias assemblies.

Optionally, the bias assembly can also have a bottom wall having an opening formed therein. The opposing bias assembly can optionally engage within the opening of the bottom wall. Additionally, the bottom wall can optionally include a plurality of bottom wall sections, where each of the bottom wall sections has a beveled end and extends from one of the side walls, respectively. The opening can be arranged between the beveled ends of the bottom wall sections. Optionally, the opposing bias assembly can engage between the beveled ends of the bottom wall sections. In this case, the top wall, the side walls and the bottom wall sections of the bias assembly and the opposing bias assembly completely enclose the force sensor. The top wall, the side walls and the bottom wall sections of the bias assembly and the opposing bias assembly therefore form the walls of the chamber.

Optionally, the bias assembly and the opposing bias assembly can be configured to engage as a snap clip. Alternatively, the force sensor module can optionally include an adhesive layer disposed between the bias assembly and the opposing bias assembly. Alternatively, the force sensor module can optionally include an ultrasonic weld disposed between the bias assembly and the opposing bias assembly. Alternatively or additionally, the bias assembly can optionally be elastically deformed by coupling with the opposing bias assembly.

Optionally, the bias assembly or the opposing bias assembly can include electronic circuitry for receiving force sensor signals from the force sensor or supplying power to the force sensor. Additionally, the force sensor can be electrically coupled to the electronic circuitry. For example, the force sensor can optionally be electrically coupled to the electronic circuitry with a solder bond. Additionally, the force sensor module can optionally include an electrical connector for receiving the force sensor signals from the electronic circuitry or supplying the power to the electronic circuitry. For example, the electrical connector can be a flexible circuit board.

Optionally, the bias assembly or the opposing bias assembly can include a raised portion that contacts at least a portion of the force sensor. The raised portion can optionally have a substantially round shape. Additionally, the raised portion can minimize or prevent a torque applied to the force sensor.

Optionally, the preload force can be approximately equal to 10% of a sensing range of the force sensor.

An example touch-sensitive electronic device can include a touch screen and a force sensor module that is adhered to the touch screen. The touch screen can have a touch surface and a rear surface opposite to the touch surface. Additionally, the force sensor module can include one or more force sensors, a bias assembly and an opposing bias assembly. The bias assembly can have a top wall and a plurality of side walls extending from the top wall. The top and side walls can define a chamber. The force sensors can be arranged between the bias assembly and the opposing bias assembly within the chamber. Additionally, the bias and opposing bias assemblies can be configured to apply a preload force to each of the force sensors, which is approximately equal to a spring force exerted between the bias and opposing bias assemblies.

Optionally, the bias assembly can also have a bottom wall having an opening formed therein. The opposing bias assembly can optionally engage within the opening of the bottom wall. Additionally, the bottom wall can optionally include a plurality of bottom wall sections, where each of the bottom wall sections has a beveled end and extends from one of the side walls, respectively. The opening can be arranged between the beveled ends of the bottom wall sections. Optionally, the opposing bias assembly can engage between the beveled ends of the bottom wall sections. In this case, the top wall, the side walls and the bottom wall sections of the bias assembly and the opposing bias assembly completely enclose the force sensors. The top wall, the side walls and the bottom wall sections of the bias assembly and the opposing bias assembly therefore form the walls of the chamber.

Optionally, the bias assembly and the opposing bias assembly can be configured to engage as a snap clip. Alternatively, the force sensor module can optionally include an adhesive layer disposed between the bias assembly and the opposing bias assembly. Alternatively, the force sensor module can optionally include an ultrasonic weld disposed between the bias assembly and the opposing bias assembly. Alternatively or additionally, the bias assembly can optionally be elastically deformed by coupling with the opposing bias assembly.

Optionally, the preload force can be approximately equal to 10% of a sensing range of the one or more force sensors.

Alternatively or additionally, the touch-sensitive electronic device can optionally include a case for accommodating the touch screen and the force sensor module. The force sensor module can be arranged between the touch screen and the case. Optionally, the force sensor module can be adhered to the case.

Optionally, the touch-sensitive electronic device can include a display device. The display device can be a liquid crystal display (LCD), a light emitting diode (LED) display, an organic LED (OLED) display or other type of display. The display device can be arranged between the touch screen and the case, for example. Additionally, the force sensor module can optionally be arranged at least partially around a perimeter of the display device. For example, the force sensor module can be arranged in a closed loop around the perimeter of the display device.

Alternatively or additionally, the touch screen can optionally be a capacitive touch screen. Optionally, each of the capacitive touch screen and the force sensor module can include electronic circuitry for receiving capacitive touch signals or force sensor signals, respectively, or supplying power to the capacitive touch screen or the one or more force sensors, respectively.

Optionally, the touch-sensitive electronic device can include at least one controller for processing the capacitive touch signals and the force sensor signals and at least one electrical connector for electrically connecting the electronic circuitry of the capacitive touch screen and the electronic circuitry of the force sensor module with the at least one controller. For example, the at least one electrical connector can optionally be a flexible circuit board.

An example method for manufacturing a force sensor module for a touch-sensitive electronic device can include providing a bias assembly having a top wall and a plurality of side walls extending from the top wall. The top wall and the side walls can define a chamber configured to receive a force sensor therein. The method can also include providing an opposing bias assembly. The bias assembly or the opposing bias assembly can include electronic circuitry for receiving signals from or supplying power to the force sensor. The method can further include bonding the force sensor to the electronic circuitry of the bias assembly or the opposing bias assembly. Additionally, the method can include coupling the bias assembly and the opposing bias assembly such that the force sensor is arranged between bias assembly and the opposing bias assembly within the chamber. The bias and opposing bias assemblies can be configured to apply a preload force to the force sensor, which is approximately equal to a spring force exerted between the bias and opposing bias assemblies.

Optionally, the bias assembly and the opposing bias assembly can be configured to engage as a snap clip. In this case, the method can further include applying a force to engage the bias assembly and the opposing bias assembly. The bias assembly can optionally be elastically deformed by coupling with the opposing bias assembly.

Alternatively, the method can further include applying an adhesive layer between the bias assembly and the opposing bias assembly and curing the adhesive layer. When the adhesive layer is cured, a thickness of the adhesive layer shrinks. The bias assembly can optionally be elastically deformed by coupling with the opposing bias assembly.

Alternatively, the method can further include aligning the bias assembly and the opposing bias assembly, applying a force to the bias assembly or the opposing bias assembly and ultrasonically welding the bias assembly and the opposing bias assembly. The bias assembly can optionally be elastically deformed by coupling with the opposing bias assembly.

Alternatively or additionally, the method can further include providing a touch screen having a touch surface and a rear surface opposite to the touch surface and adhering the coupled bias assembly and the opposing bias assembly to the rear surface of the touch screen. The touch screen can optionally be a capacitive touch screen.

Optionally, the preload force can be approximately equal to 10% of a sensing range of the force sensor.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIGS. 1A-1B are exploded views illustrating force sensor modules and touch screens according to example implementations described herein;

FIG. 2A is a cross-sectional view illustrating the force sensor module shown in FIG. 1B along line A-A′;

FIG. 2B is a magnified view of illustrating the force sensor module shown in FIG. 2A;

FIGS. 3A-3B are cross-sectional views illustrating force sensor modules according to example implementations described herein;

FIG. 3C is a free body diagram illustrating forces exerted by the force sensor modules shown in FIGS. 3A-3B;

FIGS. 4A-4B are cross-sectional views illustrating a force sensor module according to example implementations described herein;

FIGS. 5A-5B are cross-sectional views illustrating force sensor modules according to example implementations described herein;

FIG. 6 is a block diagram illustrating an example touch-sensitive electronic device according to an example implementation described herein; and

FIG. 7 is a flow diagram illustrating example operations for manufacturing force sensor modules according to implementations described herein.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. While implementations will be described for providing a force sensor module for use with a touch-sensitive electronic device, it will become evident to those skilled in the art that the implementations are not limited thereto. As used herein, a touch-sensitive electronic device is an electronic device having a touch-sensitive human machine interface (“HMI”). Optionally, the touch-sensitive electronic device can be a consumer electronic device such as a tablet computer or mobile phone, for example. It should be understood, however, that these are provided only as examples and that this disclosure contemplates that the touch-sensitive electronic device can be any type of electronic device.

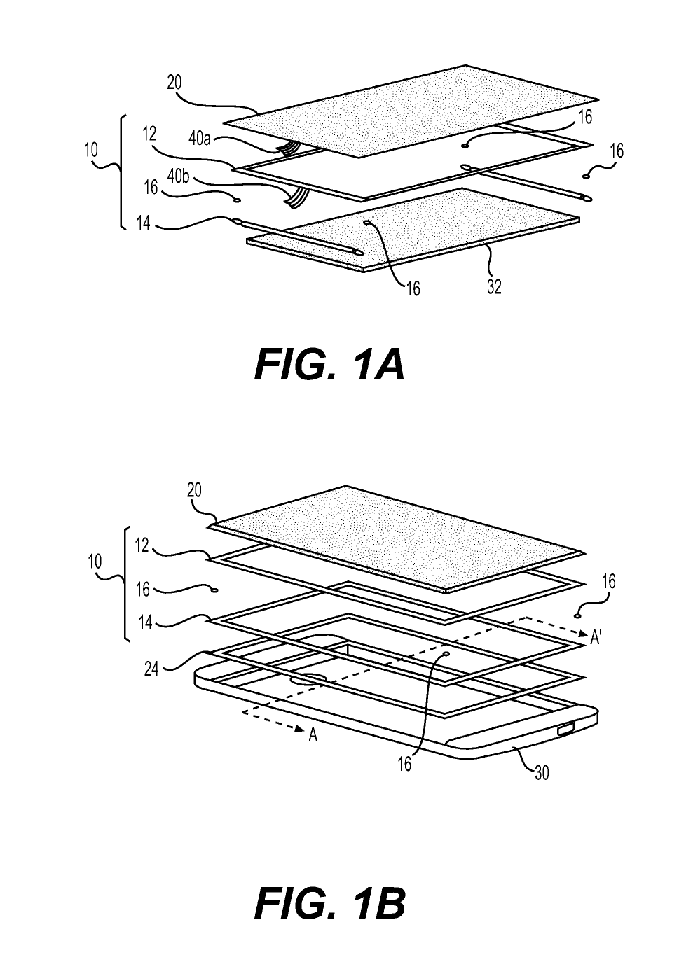

Referring now to FIGS. 1A-1B, exploded views illustrating example force sensor modules and touch screens are shown. For example, a force sensor module 10 can include a bias assembly 12, an opposing bias assembly 14 and one or more force sensors 16. The bias assembly 12 and the opposing bias assembly 14 can be made from various materials, including but not limited to, metals, plastics and films (e.g., of metals, oxides, plastics, polymers, monomers, etc.). The bias assembly 12 and the opposing bias assembly 14 can be complementary and form a closed-loop shape (e.g., a rectangle, ring, etc.) as shown in FIG. 1B. Alternatively, the opposing bias assembly 14 can include one or more portions (e.g., end caps) for enclosing the force sensors 16 as shown in FIG. 1A. The force sensors 16 can be arranged between the bias assembly 12 and the opposing bias assembly 14. As described in detail below, the bias assembly 12 and the opposing bias assembly 14 can be configured to apply a preload force to the force sensors 16. In FIGS. 1A-1B, the force sensors 16 are provided at each of the corners of the force sensor module 10. The force sensors 16 can be used to detect both a location (e.g., x- and y-axes) and a magnitude (e.g., a z-axis) of an applied force. It should be understood that this configuration is provided only as an example and that other numbers of force sensors, as well as different arrangements within the force sensor module, can be used. Optionally, a force sensor as used herein can be a piezoresistive, piezoelectric or capacitive sensor. For example, the force sensor can be configured to change at least one electrical characteristic (e.g., resistance, charge, capacitance, etc.) based on an amount or magnitude of an applied force and can output a signal proportional to the amount or magnitude of the applied force. Alternatively or additionally, a force sensor as used herein can be a microelectromechanical (“MEMS”) sensor.

As described above, the force sensor module 10 can be used in a touch-sensitive electronic device. The force sensor module 10 can optionally be arranged between a touch screen 20 and a case 30 of the touch-sensitive electronic device (FIG. 1A). Alternatively or additionally, the touch-sensitive electronic device can include a display device 32 (FIG. 1B). Optionally, the force sensor module 10 can be arranged between the touch screen 20 and the case 30 of the touch-sensitive electronic device around a perimeter of the display device 32. Optionally, an adhesive layer can be used to adhere or bond the force sensor module 10 to the touch screen 20 and/or the case 30. The adhesive layer can optionally be a pressure sensitive adhesive (“PSA”). For example, the adhesive layer can be double-sided tape. This disclosure also contemplates using an adhesive layer other than a PSA such as structural adhesives, for example. An adhesive layer 24 is shown in FIG. 1B, which adheres the force sensor module 10 to the case 30. Although the adhesive layer 24 in FIG. 1B is provided between an entire perimeter of the force sensor module 10 and the case 30, it should be understood that the adhesive layer can be provided between one or more portions of the force sensor module 10 and the case 30.

Optionally, the touch screen 20 can be a capacitive touch screen. An example capacitive touch screen can be an insulator (e.g., glass) with a conductive material coated thereon. The conductive material can be a conductive layer, grid (e.g., rows and columns), array, etc. Optionally, the conductive material can be transparent such as indium tin oxide (“ITO”). A voltage can be applied to the conductive material to generate an electrostatic field. Then, when a conductor (e.g., a human finger) contacts the touch screen 20, the local electrostatic field is distorted. Using a touch screen controller, it is possible to detect/measure this local distortion as a change in capacitance and determine one or more touch locations or positions (e.g., x- and y-axes) on the touch screen 20. As shown in FIG. 1A, the touch screen 20 can include an electrical connector 40A. The electrical connector 40A can facilitate transmission of capacitive touch signals to the touch screen controller and/or can supply power to the touch screen 20. Similarly, the force sensor module 10 can include an electrical connector 40B. The electrical connector 40B can facilitate transmission of force touch signals to a force sensor controller and/or can supply power to the force sensors 16. Optionally, the electrical connectors 40A and/or 40B can be flexible circuit boards (“FCB”). Although multiple electrical connectors are shown in FIG. 1A, a single electrical connector can optionally be used to facilitate transmission of capacitive touch signals and force sensor signals to one or more controllers, as well as supply power to the touch screen 20 and the force sensors 16.

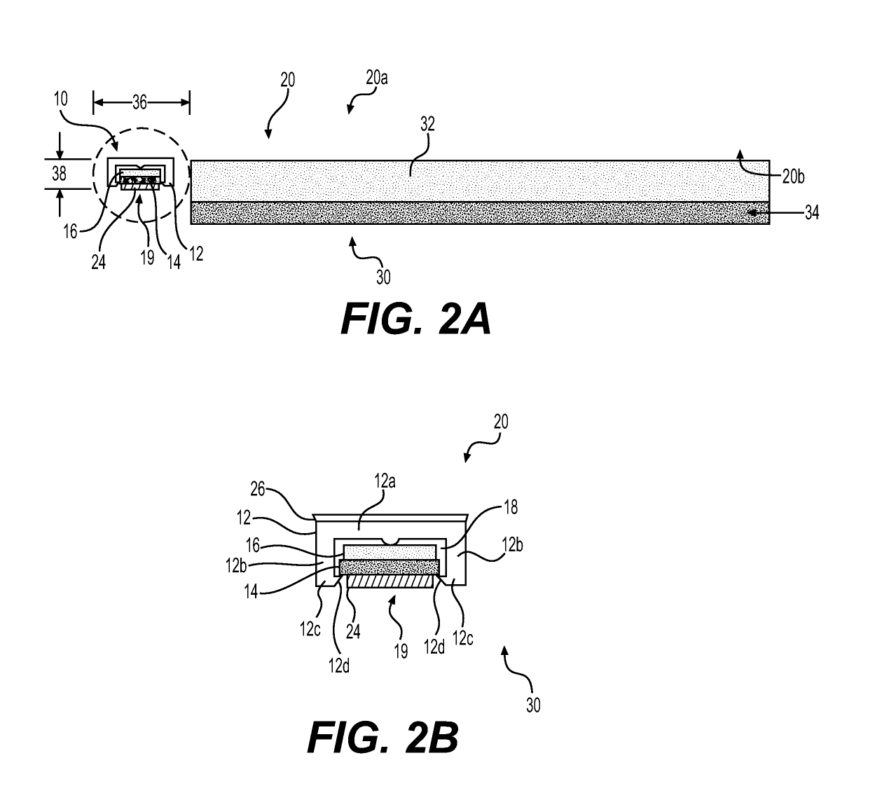

Referring now to FIGS. 2A-2B, a cross-sectional view illustrating the force sensor module 10 shown in FIG. 1B along line A-A′ is shown. FIG. 2B is a magnified view of the force sensor module shown in FIG. 2A. The force sensor module 10 can include the bias assembly 12, the opposing bias assembly 14 and the force sensor 16. In addition, the force sensor 16 can be arranged between the bias assembly 12 and the opposing bias assembly 14 when the bias assembly 12 and opposing bias assembly 14 are coupled together. For example, the bias assembly 12 can have a top wall 12A and a plurality of side walls 12B, where each of the side walls 12B extends from the top wall 12A. Optionally, the side walls 12B can extend from opposite ends of the top wall 12A. The top wall 12A and the side walls 12B can define a chamber 18, and the force sensor 16 can be arranged between the bias assembly 12 and the opposing bias assembly 14 within the chamber 18. The bias assembly 12 and opposing bias assembly 14 can be configured to apply a preload force to the force sensor 16. As described in detail below, the preload force can be approximately equal to a spring force exerted between the bias assembly 12 and opposing bias assembly 14.

In some implementations, the bias assembly 12 and the opposing bias assembly 14 can be configured to engage as a snap clip. For example, the bias assembly 12 can optionally have a bottom wall 12C having an opening 19 formed therein. Optionally, the bottom wall 12C can include a plurality of bottom wall sections, where each of the bottom wall sections has a beveled end 12D and extends from one of the side walls 12B, respectively. The opening 19 can optionally be arranged between the beveled ends 12D. As shown in FIGS. 2A-2B, the opposing bias assembly 14 can optionally engage within the opening 19 of the bottom wall 12C. Optionally, the opposing bias assembly 14 can engage between the beveled ends 12D. Accordingly, the top wall 12A, the side walls 12B and the bottom wall 12C (e.g., the bottom wall sections having the beveled ends 12D) of the bias assembly 12 and the opposing bias assembly 14 completely enclose the force sensor 16. The top wall 12A, the side walls 12B and the bottom wall sections of the bias assembly 12 and the opposing bias assembly 14 therefore form the walls of the chamber 18. For example, in FIGS. 2A-2B, the top wall 12A, the side walls 12B and the bottom wall sections of the bias assembly 12 and the opposing bias assembly 14 form the four walls of the chamber 18.

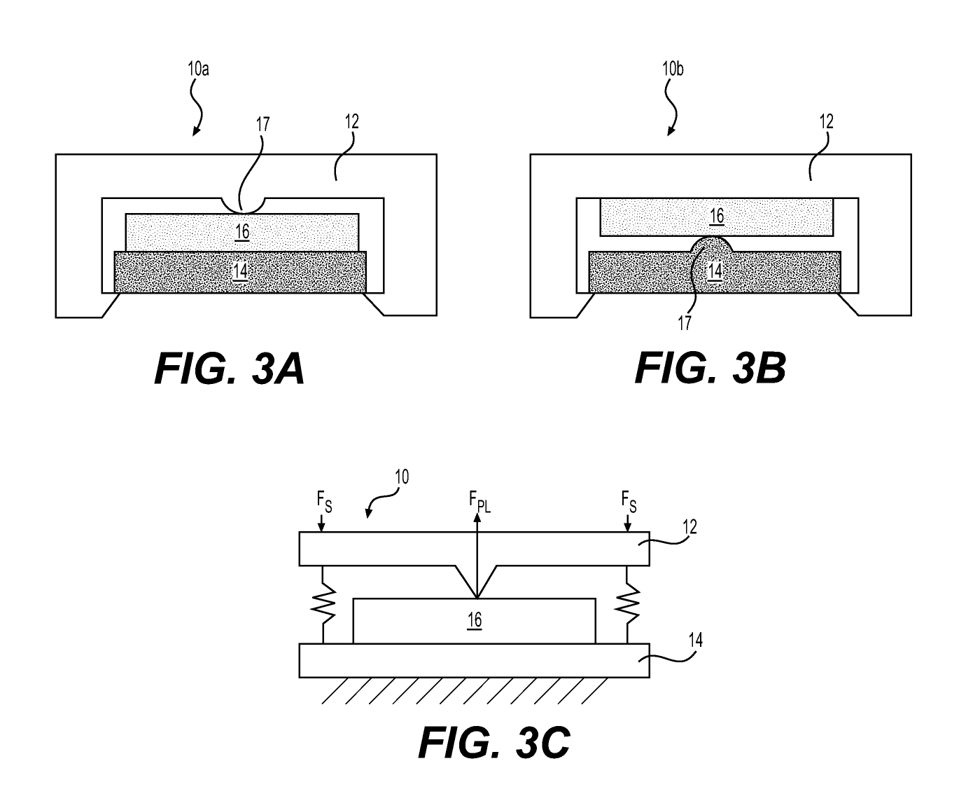

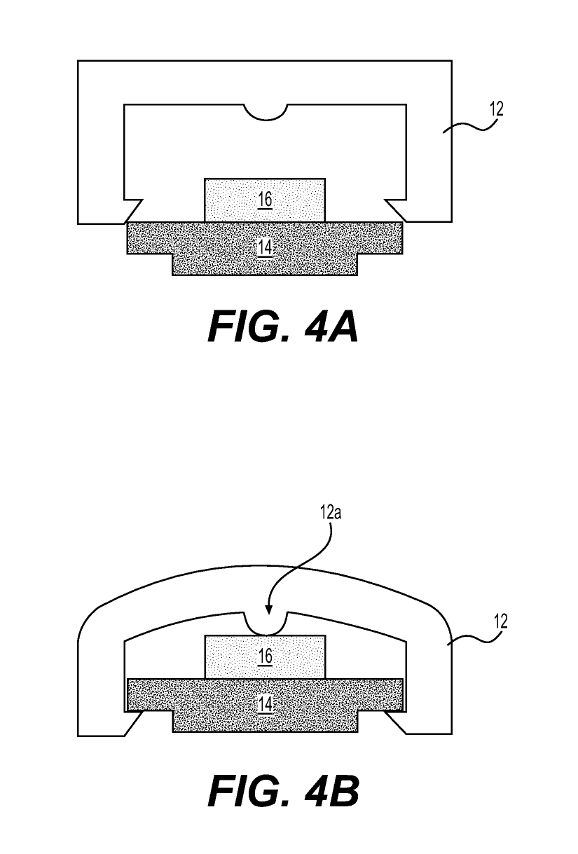

Referring now to FIGS. 3A-3B, cross-sectional views illustrating force sensor modules 10A and 10B are shown. The force sensor modules 10A and 10B can include many of the same features as the force sensor module 10 described above with regard to FIGS. 1A-2B, and therefore, these same features are not described in detail below. For example, each of the force sensor modules 10A and 10B can include the bias assembly 12, the opposing bias assembly 14 and the force sensor 16. The bias assembly 12 and the opposing bias assembly 14 of each of the force sensor modules 10A and 10B can be configured to engage as a snap clip as described above. Additionally, the force sensor modules 10A and 10B can be configured to apply a preload force to the force sensor 16. The preload force can be equal to a spring force exerted between the bias assembly 12 and the opposing bias assembly 14. As used herein, a spring force is a force exerted by a compressed or stretched spring upon an object that compresses or stretches the spring. In FIGS. 3A-3B, the bias assembly 12 and the opposing bias assembly 14 can exert a spring force there between when coupled together, and the force sensor 16 can be the object on which the spring force is exerted. For example, when the bias assembly 12 and the opposing bias assembly 14 are engaged or coupled together, the bias assembly 12 can optionally be elastically deformed, which results in a spring force being exerted between the bias assembly 12 and the opposing bias assembly 14. This is illustrated by FIGS. 4A-4B. In FIG. 4A, the bias assembly 12 and the opposing bias assembly 14 are not engaged. Then, in FIG. 4B, the bias assembly 12 and the opposing bias assembly 14 are engaged with the force sensor 16 arranged there between as a snap clip, and the top surface 12A of the bias assembly 12 is elastically deformed, which causes a spring force to be exerted.

Referring now to FIG. 3C, a free body diagram illustrating forces exerted by the force sensor modules shown in FIGS. 3A-3B is shown. The force sensor module 10 can include the bias assembly 12, the opposing bias assembly 14 and the force sensor 16. The force sensor module 10 can be configured to apply a preload force (F_{PL}) to the force sensor 16. Optionally, the preload force can be exerted between the bias assembly 12 and the opposing bias assembly 14 when coupled together, for example, due to elastic deformation of the bias assembly 12. The preload force can be equal to a spring force (F_{S}) exerted between the bias assembly 12 and the opposing bias assembly 14. Optionally, the preload force can be described by Eqn. (1) below.

F_{PL}≈2×F_{S} (1)

where F_{S} is a spring force exerted by each of the snap clips. It should be understood that the amount of the spring force (F_{S}) can be determined by the materials and/or dimensions of the bias assembly 12 and the opposing bias assembly 14. Additionally, the preload force can be designed to not exceed a predetermined percentage of a force sensing range of a force sensor such as 10% (e.g., 1N for a force sensor with a 10N range). Alternatively or additionally, the preload force can have a predetermined tolerance such as +/−20% (e.g., 0.8N-1.2N for a 1N preload force). It should be understood that the predetermined percentage and/or the predetermined tolerance can have values other than those provided above, which are used only as examples.

Referring again to FIGS. 3A-3B, the bias assembly 12 or the opposing bias assembly 14 can include electronic circuitry for receiving force sensor signals from the force sensor 16 and/or supplying power to the force sensor 16. In FIG. 3A, the opposing bias assembly 14 can include the electronic circuitry. In FIG. 3B, the bias assembly 12 can include the electronic circuitry. Optionally, the electronic circuitry can be embedded in at least a portion of the bias assembly 12 or the opposing bias assembly 14, which can be made from various materials, including but not limited to, metals, plastics and films, as described above. Then, as shown in FIGS. 3A-3B, the force sensor 16 can be electrically coupled to the electronic circuitry of either the opposing bias assembly 14 or the bias assembly 12, respectively. For example, the force sensor 16 can optionally be electrically coupled to the electronic circuitry with a solder bond. Alternatively or additionally, the bias assembly 12 or the opposing bias assembly 14 can include a raised portion 17 that contacts at least a portion of the force sensor 16. The raised portion 17 can be provided on a portion of the force sensor module opposite to a portion of the force sensor module to which the force sensor 16 is electrically coupled. For example, as shown in FIG. 3A, the raised portion 17 is provided on the bias assembly 12 and contacts the force sensor 16. As shown in FIG. 3B, the raised portion 17 is provided on the opposing bias assembly 14 and contacts the force sensor 16. The raised portion 17 can be configured to prevent or minimize the amount of torque applied to the force sensor 16. For example, the raised portion 17 can optionally have a substantially round shape. When the raised portion 17 has a rounded shape (e.g., as shown in FIGS. 3A-3B), the raised portion 17 imparts an approximately point load (as opposed to a load applied over an area) on the force sensor 16, which helps minimize the amount of torque applied to the force sensor 16. Although a raised portion with a rounded shape is provided as an example in FIGS. 3A-3B, this disclosure contemplates that the raised portion 17 can have other shapes.

Referring again to FIGS. 2A-2B, the force sensor module 10 can optionally be used in a touch-sensitive electronic device. The force sensor module 10 can optionally be arranged between the touch screen 20 and the case 30 of the touch-sensitive electronic device. Additionally, the force sensor module 10 can be adhered or bonded to the touch screen 20 using an adhesive layer 26, for example. The force sensor module 10 therefore facilitates bonding of preloaded force sensors to the touch screen 20 such that the touch screen 20 is always in contact with the force sensors. Alternatively or additionally, the force sensor module 10 can be adhered or bonded to the case 30 using an adhesive layer 24, for example. The adhesive layers 24 or 26 can optionally be a PSA or other structural adhesive, as described above. For example, the adhesive layer 26 used to bond the force sensor module 10 and the touch screen 20 can optionally be a PSA, an ultraviolet (“UV”) cure adhesive or an UV epoxy adhesive. Alternatively or additionally, the adhesive layer 24 used to bond the force sensor module 10 and the case 30 can optionally be a PSA such as double-sided tape, for example. As described above, the touch-sensitive electronic device can include a display device 32. The display device 32 can be an LCD, an LED display, an OLED display or any other type of display. The display device 32 can be arranged between the touch screen 20 and the case 30, for example. Optionally, the touch-sensitive electronic device can include other electronics 34 such as display drivers, power supplies, computing devices, etc. arranged between the display device 32 and the case 32.

The force sensor module 10 can optionally be arranged at least partially around a perimeter of the display device 32. For example, the force sensor module 10 can optionally be arranged in a closed loop around the perimeter of the display device 32. Accordingly, the force sensor module 10 can be provided in a bezel area 36 of the case 30 of the touch-sensitive electronic device without adding substantial thickness. For example, a thickness 38 of the force sensor module 10 can be approximately 500 μm. It should be understood that 500 μm is provided only as an example thickness and that the thickness is dependent on the design of the bias assembly 12, the opposing bias assembly 14 and/or the force sensor 16.

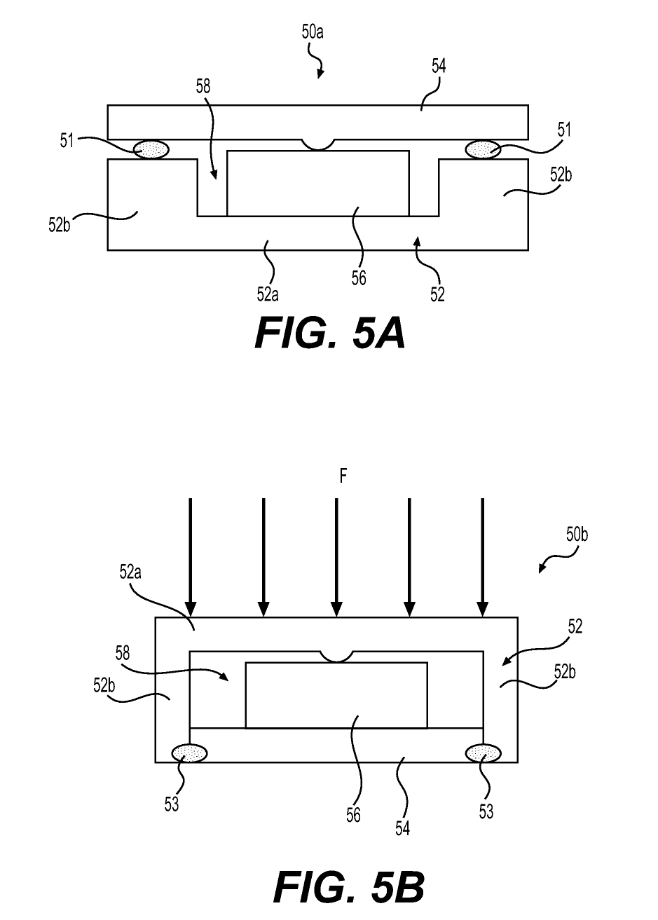

Referring now to FIGS. 5A-5B, cross-sectional views illustrating force sensor modules are shown. In particular, FIG. 5A illustrates a force sensor module 50A including a bias assembly 52, an opposing bias assembly 54, and a force sensor 56. The force sensor 56 can be arranged between the bias assembly 52 and the opposing bias assembly 54 when the bias assembly 52 and the opposing bias assembly 54 are coupled together. An adhesive layer 51 can be arranged between the bias assembly 52 and the opposing bias assembly 54. For example, similar as described above, the bias assembly 52 can have a top wall 52A and a plurality of side walls 52B, where each of the side walls 52B extends from the top wall 52A. The top wall 52A and the side walls 52B can define a chamber 58, and the force sensor 56 can be arranged between the bias assembly 52 and the opposing bias assembly 54 within the chamber 58. The adhesive layer 51 can be arranged between the side walls 52B and the opposing bias assembly 54. When the adhesive layer 51 is cured, the adhesive layer 51 can shrink, which causes the bias assembly 52 and the opposing bias assembly 54 to apply a preload force to the force sensor 56. Optionally, when the bias assembly 52 and the opposing bias assembly 54 are engaged or coupled together with the adhesive layer 51, the bias assembly 52 can optionally be elastically deformed, which results in a spring force being exerted between the bias assembly 52 and the opposing bias assembly 54. The preload force can be approximately equal to a spring force exerted between the bias assembly 52 and opposing bias assembly 54 as described above.

FIG. 5B illustrates a force sensor module 50B including a bias assembly 52, an opposing bias assembly 54, and a force sensor 56. The force sensor 56 can be arranged between the bias assembly 52 and the opposing bias assembly 54 when the bias assembly 52 and the opposing bias assembly 54 are coupled together. The bias assembly 52 and the opposing bias assembly 54 can be ultrasonically welded (e.g., through ultrasonic welds 53) together. For example, the bias assembly 52 can have a top wall 52A and a plurality of side walls 52B, where each of the side walls 52B extends from the top wall 52A. The top wall 52A and the side walls 52B can define a chamber 58, and the force sensor 56 can be arranged between the bias assembly 52 and the opposing bias assembly 54 within the chamber 58. The opposing bias assembly 54 can be designed to fit between the side walls 52B. The ultrasonic welds 53 can be arranged between the side walls 52B and the opposing bias assembly 54. For example, the bias assembly 52 can be aligned with the opposing bias assembly 54. Then, after applying a force to fit the opposing bias assembly 54 between the side walls 52B, the bias assembly 52 and the opposing bias assembly 54 can be ultrasonically welded together. When the bias assembly 52 and the opposing bias assembly 54 are engaged or coupled together with the ultrasonic welds 53, the bias assembly 52 can optionally be elastically deformed, which results in a spring force being exerted between the bias assembly 52 and the opposing bias assembly 54. The preload force can be approximately equal to a spring force exerted between the bias assembly 52 and opposing bias assembly 54 as described above.

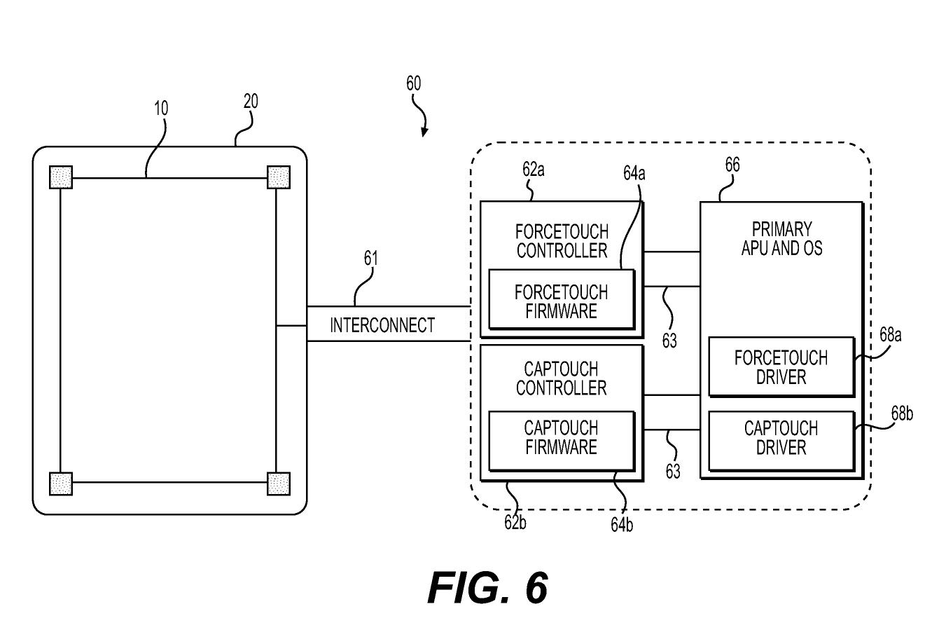

Referring now to FIG. 6, a block diagram illustrating an example touch-sensitive electronic device 60 is shown. The touch-sensitive electronic device 60 can include a force sensor module 10 and a touch screen 20. The force sensor module 10 and the touch screen 20 are described in detail above and are therefore not described in further detail below. Optionally, the touch-sensitive electronic device 60 can include a display device, which is also described in detail above. The touch-sensitive electronic device 60 can also include at least one controller configured to process the capacitive touch signals from the touch screen 20 and/or the force sensor signals from the force sensor(s) of the force sensor module 10. For example, as shown in FIG. 6, the touch-sensitive electronic device 60 can include a force sensor controller 62A and a touch screen controller 62B. In its most basic configuration, a controller typically includes at least one processing unit and memory. The processing unit can be a standard programmable processor that performs arithmetic and logic operations necessary for operation of the controller. The processing unit can be configured to execute program code encoded in tangible, computer-readable media such as the memory. For example, the force sensor controller 62A and the touch screen controller 62B can include a force sensor module 64A and a touch screen module 64B, respectively, for storing a sequence of computer implemented acts or program modules (e.g., software, firmware, etc.). Optionally, the force sensor controller 62A can be configured to receive the force sensor signals and determine a location (e.g., x- and y-axes) and a magnitude (e.g., a z-axis) of an applied force. In addition, the force sensor controller 62A can optionally be configured to compensate for the preload force applied to each of the force sensors by the force sensor module 10. Alternatively or additionally, the touch screen controller 62B can be configured to receive the touch screen signals and determine a location (e.g., x- and y-axes) of an applied force.

The force sensor module 10 and the touch screen 20 can be communicatively connected to the force sensor controller 62A and the touch screen controller 62B, respectively, through a communication link 61. This disclosure contemplates the communication link 61 is any suitable communication link. For example, a communication link may be implemented by any medium that facilitates data exchange between the network elements including, but not limited to, wired, wireless and optical links. Optionally, the communication link 61 can be the electrical connector 40A and/or 40B described above with regard to FIG. 1A (e.g., an FCB). This disclosure contemplates that the communication link 61 can be a single communication link or multiple communication links connecting the force sensor module 10 to the force sensor controller 62A and the touch screen 20 to the touch screen controller 62B. Additionally, as described above, the communication link 61 can be used to facilitate transmission of force sensor and/or capacitive touch signals and/or supply power to the force sensor(s) and/or the touch screen.

In addition, the touch-sensitive electronic device 60 can include an advanced processing unit (“APU”) 66. The APU 66 can be configured to perform operations necessary for operation of the touch-sensitive electronic device 60. Similar to the controller described above, the APU 66 typically includes at least one processing unit and memory. The processing unit can be a standard programmable processor that performs arithmetic and logic operations necessary for operation of the APU 66. The processing unit can be configured to execute program code encoded in tangible, computer-readable media such as the memory. In addition, the force sensor controller 62A and the touch screen controller 62B can be communicatively connected to the APU 66 through one or more communication links 63. Similar as described above, this disclosure contemplates the communication links 63 are any suitable communication link.

The force sensor module 10 and the touch screen 20 can provide a hybrid force/capacitive HMI for the touch-sensitive electronic device 60. Accordingly, the force sensor controller 62A can communicate the location (e.g., x- and y-axes) and magnitude (e.g., a z-axis) of the applied force to the APU 66. Alternatively or additionally, the touch screen controller 62B can communicate the location (e.g., x- and y-axes) of the applied force to the APU 66. Optionally, the APU 66 can include a force sensor driver 68A and a touch screen driver 68B, respectively, for storing a sequence of computer implemented acts or program modules (e.g., software, firmware, etc.) to facilitate communication between the respective controllers and the APU 66. This disclosure contemplates that one or more applications and/or operating systems executing on the APU 66 can be configured to use this data to control operations of the touch-sensitive electronic device 60.

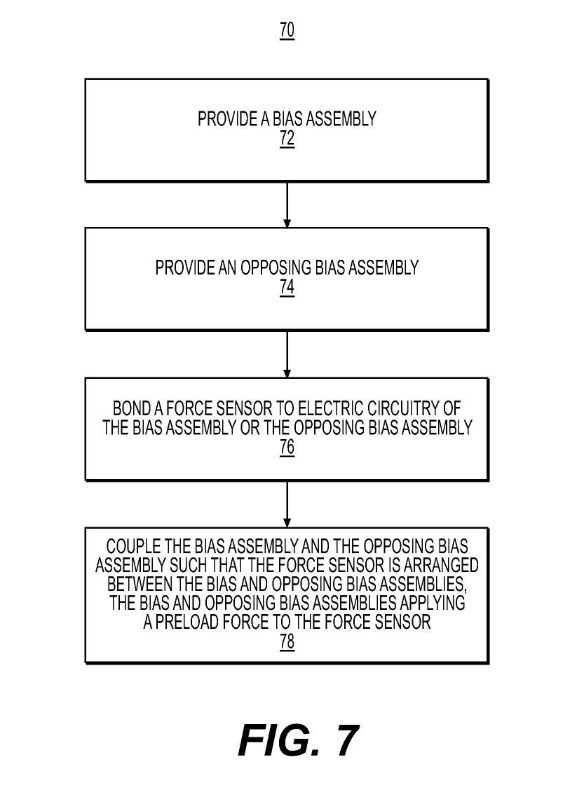

Referring now to FIG. 7, a flow diagram illustrating example operations 70 for manufacturing force sensor modules for a touch-sensitive electronic device are shown. At 72, a bias assembly having a top wall and a plurality of side walls extending from the top wall can be provided. The top wall and the side walls can define a chamber configured to receive a force sensor therein. At 74, an opposing bias assembly can be provided. It should be understood that the bias assembly and the opposing bias assembly can be any of the examples described above with regard to FIGS. 1A-5B. At 76, the force sensor can be bonded to electronic circuitry of the bias assembly or the opposing bias assembly. At 78, the bias assembly and the opposing bias assembly can be coupled such that the force sensor is arranged between the bias assembly and the opposing bias assembly within the chamber. As described in detail above, the bias and opposing bias assemblies can be configured to apply a preload force to the force sensor, which is approximately equal to a spring force exerted between the bias and opposing bias assemblies.

According to implementations described herein, the force sensor module serves one or more of the functions below. The force sensor module mechanically packages the force sensors and optionally provides a degree of environmental protection. The force sensor module provides an interface for facilitating transmission of force sensor signals and/or power from/to the force sensors. The force sensor module facilitates bonding of preloaded force sensors to a touch screen such that the touch screen is always in contact with the force sensors. The force sensor module replaces the adhesive layer used to bond a touch screen (e.g., a capacitive touch screen) to a touch-sensitive electronic device. The force sensor module minimizes or prevents torque applied to the force sensors. The force sensor module eliminates reverse loading or peel force on the force sensors.

The force sensor module also facilitates providing a hybrid touch interface (e.g., a force-sensitive and capacitive touch interface). The hybrid touch interface provides the advantages of both force-sensitive and capacitive touch screens. For example, capacitive touch screens are capable of detecting multiple-touches and have a relatively high sensitivity. Additionally, force-sensitive touch screens can be used in extreme operating environments (e.g., underwater, with gloved fingers/hands, etc.) and are capable of detecting force in three-axes (e.g., the location (X, Y) and magnitude (Z)). Detecting force in three-axes allows for the determination of touch-intent or taking action only when the applied force exceeds a specified threshold.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A force sensor module for a touch-sensitive electronic device, comprising:
a force sensor;
a bias assembly comprising a top wall and a plurality of side walls extending from the top wall, the top wall and the side walls defining a chamber configured to receive the force sensor therein; and
an opposing bias assembly coupled to the bias assembly, the force sensor being arranged between the bias assembly and the opposing bias assembly within the chamber, and the bias assembly and the opposing bias assembly exerting a spring force there between, wherein the bias assembly and the opposing bias assembly are configured to apply a preload force to the force sensor approximately equal to the spring force.

2. The force sensor module of claim 1, wherein the bias assembly further comprises a bottom wall having an opening formed therein, and wherein the opposing bias assembly engages within the opening.

3. The force sensor module of claim 2, wherein the bottom wall comprises a plurality of bottom wall sections, each of the bottom wall sections having a beveled end and extending from one of the side walls, respectively, and wherein the opening is arranged between the beveled ends of the bottom wall sections.

4. The force sensor module of claim 3, wherein the opposing bias assembly engages between the beveled ends of the bottom wall sections.

5-14. (canceled)

15. The force sensor module of claim 1, wherein the bias assembly or the opposing bias assembly includes a raised portion, the raised portion contacting at least a portion of the force sensor that is arranged between the bias assembly and the opposing bias assembly.

16-17. (canceled)

18. The force sensor module of claim 1, wherein the preload force is approximately equal to 10% of a sensing range of the force sensor.

19. A touch-sensitive electronic device, comprising:
a touch screen having a touch surface and a rear surface opposite to the touch surface; and
a force sensor module that is adhered to the touch screen, the force sensor module comprising:
one or more force sensors,
a bias assembly comprising a top wall and a plurality of side walls extending from the top wall, the top wall and the side walls defining a chamber configured to receive the force sensor therein, and
an opposing bias assembly coupled to the bias assembly, the one or more force sensors being arranged between the bias assembly and the opposing bias assembly within the chamber, and the bias assembly and the opposing bias assembly exerting a spring force there between, wherein the bias assembly and the opposing bias assembly are configured to apply a preload force to each of the one or more force sensors approximately equal to the spring force.

20. The touch-sensitive electronic device of claim 19, wherein the bias assembly further comprises a bottom wall having an opening formed therein, and wherein the opposing bias assembly engages within the opening.

21. The touch-sensitive electronic device of claim 20, wherein the bottom wall comprises a plurality of bottom wall sections, each of the bottom wall sections having a beveled end and extending from one of the side walls, respectively, and wherein the opening is arranged between the beveled ends of the bottom wall sections.

22. The touch-sensitive electronic device of claim 21, wherein the opposing bias assembly engages between the beveled ends of the bottom wall sections.

23-27. (canceled)

28. The touch-sensitive electronic device of claim 19, wherein the preload force is approximately equal to 10% of a sensing range of the one or more force sensors.

29. The touch-sensitive electronic device of claim 19, further comprising a case for accommodating the touch screen and the force sensor module, wherein the force sensor module is arranged between the touch screen and the case.

30. (canceled)

31. The touch-sensitive electronic device of claim 19, further comprising a display device, wherein the display device is arranged between the touch screen and the case, and wherein the force sensor module is arranged at least partially around a perimeter of the display device.

32. The touch-sensitive electronic device of claim 31, wherein the force sensor module is arranged in a closed loop around the perimeter of the display device.

33. (canceled)

34. The touch-sensitive electronic device of claim 19, wherein the touch screen is a capacitive touch screen.

35-37. (canceled)

38. A method for manufacturing a force sensor module for a touch-sensitive electronic device, comprising:
providing a bias assembly comprising a top wall and a plurality of side walls extending from the top wall, the top wall and the side walls defining a chamber configured to receive a force sensor therein;
providing an opposing bias assembly, wherein the bias assembly or the opposing bias assembly includes electronic circuitry for receiving signals from or supplying power to the force sensor;
bonding the force sensor to the electronic circuitry of the bias assembly or the opposing bias assembly; and
coupling the bias assembly and the opposing bias assembly, wherein the force sensor is arranged between the bias assembly and the opposing bias assembly within the chamber, wherein the bias assembly and the opposing bias assembly exert a spring force there between, and wherein the bias assembly and the opposing bias assembly are configured to apply a preload force to the force sensor approximately equal to the spring force.

39. The method of claim 38, wherein the bias assembly and the opposing bias assembly are configured to engage as a snap clip, and wherein coupling the bias assembly and the opposing bias assembly further comprises applying a force to engage the bias assembly and the opposing bias assembly.

40. The method of claim 38, wherein coupling the bias assembly and the opposing bias assembly further comprises:
applying an adhesive layer between the bias assembly and the opposing bias assembly; and
curing the adhesive layer, wherein a thickness of the adhesive layer shrinks during curing of the adhesive layer.

41. The method of claim 38, wherein coupling the bias assembly and the opposing bias assembly further comprises:
aligning the bias assembly and the opposing bias assembly;
applying a force to the bias assembly or the opposing bias assembly; and
ultrasonically welding the bias assembly and the opposing bias assembly.

42. The method of claim 38, wherein the bias assembly is elastically deformed by coupling with the opposing bias assembly.

43-45. (canceled)
